(19) United States
(12) Patent Application Publication
(10) Pub. No.: US 2018/0181131 A1
(43) Pub. Date: Jun. 28, 2018

(54) LIGHT TRANSMITTING AND RECEIVING DEVICE AND LIGHT DETECTION AND RANGING SYSTEM

(71) Applicant: HON HAI PRECISION INDUSTRY CO., LTD., New Taipei (TW)

(72) Inventor: HSIN-SHUN HUANG, Tu-Cheng (TW)

(21) Appl. No.: 15/706,837

(22) Filed: Sep. 18, 2017

(30) Foreign Application Priority Data
Dec. 27, 2016 (TW) 105143330

(51) Int. Cl. G05D 1/02; G01S 17/08; G01S 17/89; G01C 21/34; G01S 7/481; G02B 26/08

(52) U.S. Cl. CPC G05D 1/024; G01S 17/08; G01S 17/89; G02B 26/08; G05D 1/0251; G01S 7/481; G01C 21/34

(57) ABSTRACT

A light transmitting and receiving device and a light detection and ranging system are related. The device includes a light transmitting module and a light receiving module. The light transmitting module includes a light transmitter and a first focusing lens. The light receiving module includes a light receiver, and a second focusing lens. At least one of the light transmitting module and the light receiving module includes a planar waveguide including a substrate and a refracting element. Because all the refracting elements could be integrated into a planar waveguide, the required mechanism is reduced in size. The loss of optical transmission is much smaller too because the refractive index of silicon greater than the refractive index of air.

### CROSS-REFERENCE TO RELATED APPLICATIONS

This application claims all benefits accruing under 35 U.S.C. § 119 from Taiwan Patent Application No. 105143330, filed on Dec. 27, 2016, in the Taiwan Intellectual Property Office, the contents of which are hereby incorporated by reference.

### BACKGROUND

### 1. Technical Field

The present disclosure relates to a light detection and ranging system.

### 2. Description of Related Art

Light detection and ranging (LiDAR) is a technology that utilizes lasers to determine the distance to an object or surface. It is used in a variety of industries, including atmospheric physics, geology, forestry, oceanography, and law enforcement. LiDAR is similar to radar, but it incorporates laser pulses rather than radio waves. Both systems determine distance by measuring the time delay between transmission and reflection of a pulse.

Referring to FIG. 3, a light detection and ranging system 10 in prior art includes a light transmitting module 12 and a light receiving module 14. The light transmitting module 12 includes a light transmitter 120, a first focusing lens 122, and two first reflective mirrors 124. The light receiving module 14 includes a light receiver 140, a second focusing lens 142, two second reflective mirrors 144, and a filter 146. The first laser light 128 emitted from the light transmitter 120 reaches and passes through the first focusing lens 122 after being reflected by the two first reflective mirrors 124. The first laser light 128 would be reflected by the object to form a second laser light 148. The second laser light 148 passes through the second focusing lens 142 and reaches the filter 146 after being reflected by the two second reflective mirrors 144. The second laser light 148, that pass through the filter 146, are absorbed by the light receiver 140. However, the light detection and ranging system 10 is less integrated and has a larger size.

What is needed, therefore, is to provide a light detection and ranging system that can overcome the problems as discussed above.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, like reference numerals designate corresponding parts throughout the several views.

FIG. 1 is a schematic section view of one exemplary embodiment of a light detection and ranging system.

FIG. 2 shows a schematic view of one exemplary embodiment of a second planar waveguide.

FIG. 3 is a schematic section view of a light detection and ranging system in prior art.

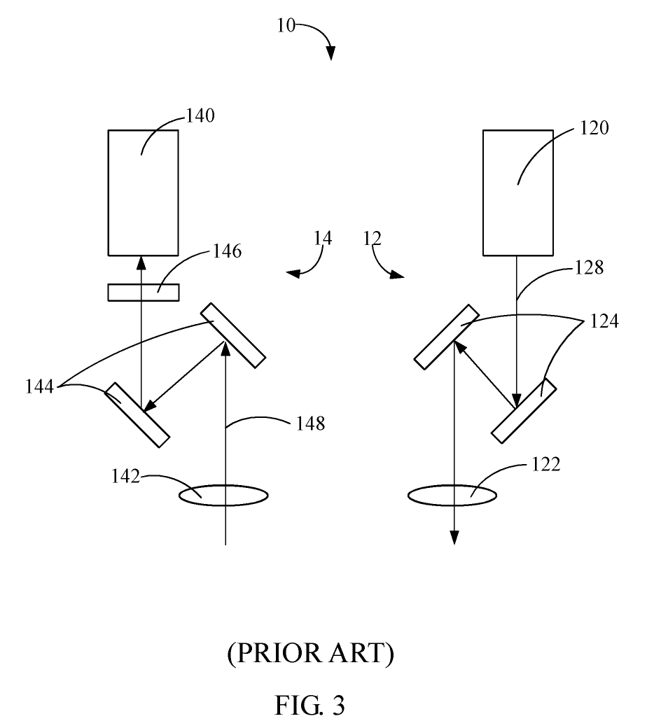

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to considered as limiting the scope of the exemplary embodiments described herein.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” exemplary embodiment in this disclosure are not necessarily to the same exemplary embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

References will now be made to the drawings to describe, in detail, various exemplary embodiments of the present light detection and ranging system.

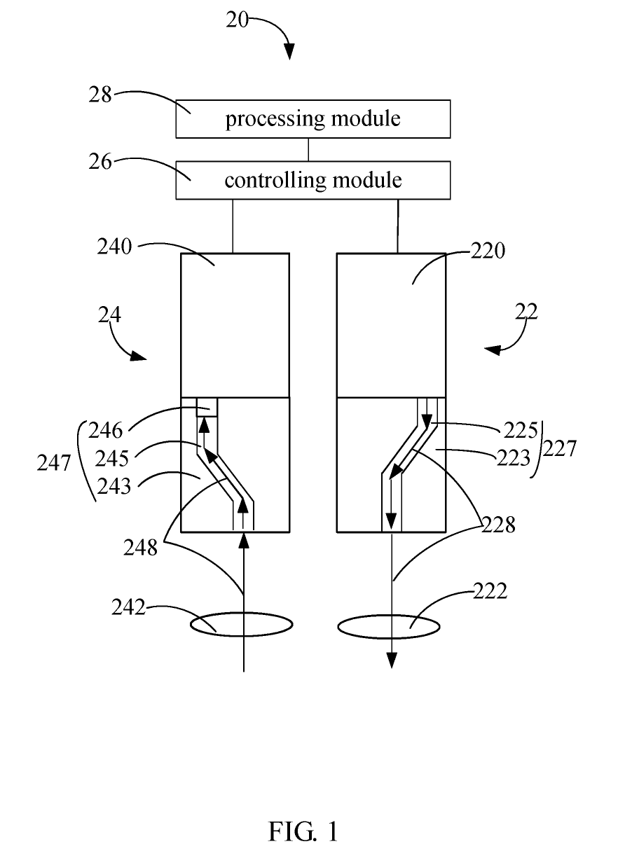

Referring to FIG. 1, a light detection and ranging system 20 of one exemplary embodiment includes a light transmitting module 22 and a light receiving module 24. The light transmitting module 22 includes a light transmitter 220, a first focusing lens 222, and a first planar waveguide 227. The light receiving module 24 includes a light receiver 240, a second focusing lens 242, and a second planar waveguide 247. The light transmitter 220 emits first laser light 228, and the light receiver 240 acquires second laser light 248. The light transmitting module 22 and the light receiving module 24 are packaged in a housing (not shown) to form a light transmitting and receiving device. The light detection and ranging system 20 further includes a controlling module 26 respectively connected to the light transmitting module 22 and the light receiving module 24, and a processing module 28 connected to the controlling module 26. The first planar waveguide 227 or the second planar waveguide 247 can be replaced by two conventional reflective mirrors.

The first planar waveguide 227 includes a first substrate 223 and a first refracting element 225 located on a surface of the first substrate 223. The first planar waveguide 227 is adjacent to a light exit surface of the light transmitter 220 so that the first laser light 228 can enter the first refracting element 225, and reach and pass through the first focusing lens 222 after being refracted by the first refracting element 225.

The second planar waveguide 247 includes a second substrate 243 and a second refracting element 245 located on a surface of the second substrate 243. The second planar waveguide 247 is adjacent to a light incidence surface of the light receiver 240 so that the second laser light 248 can enter the light receiver 240 after being refracted by the second refracting element 245. The second laser light 248 can enter the second refracting element 245 after passing through the second focusing lens 242.

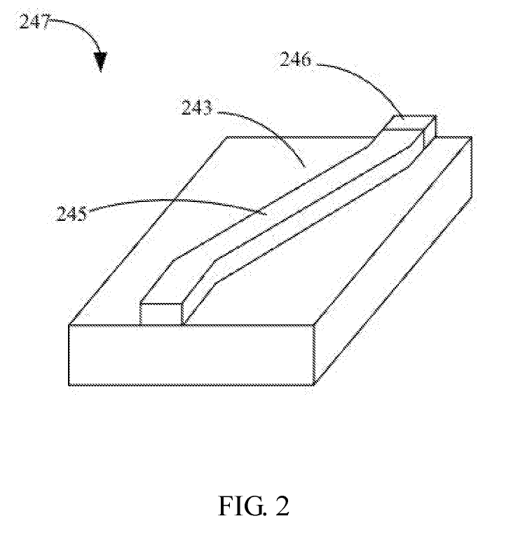

The light receiving module 24 can further include a filter 246 to filter the unnecessary noise light signal. As shown in FIG. 2, the filter 246 and the second refracting element 245 can be integrated and formed on the same surface of the second substrate 243. Thus, the light transmitting and receiving device can have a smaller size. The filter 246 and the second refracting element 245 can have the same thickness and width. The filter 246 can be located on the light exit surface or light incidence surface of the second refracting element 245. The refractive index Δn of the filter 246 satisfies the formula (1):

$$Δ n = {n}_{2} - {n}_{3} > \frac{{m}_{a}^{2} {λ}_{0}^{2}}{16 ( {n}_{2} + {n}_{3} ) {t}_{g}^{2}} \qquad ( 1 )$$

where n₂ represents the refractive index of the first refracting element 225 or the second refracting element 245, n₃ represents the refractive index of the first substrate 223 or the second substrate 243, mₐ represents the modal number of the light in the first planar waveguide 227 or the second planar waveguide 247, t_{g} represents the thickness of the first refracting element 225 or the second refracting element 245, and λ₀ represents the wavelength of the light. When the first planar waveguide 227 or the second planar waveguide 247 is asymmetrical, n₂>n₃>>n₁, the modal number of the light in the first planar waveguide 227 or the second planar waveguide 247 is odd, mₐ=1, 3, 5, 7, 9 . . . , where n₁ represents the refractive index of the air.

The material of the first substrate 223 and the second substrate 243 can be sapphire, Si₃N₄, SiO₂, GaAs, GaN, LiNbO₃, or LiTaO₃. The material of the first refracting element 225 and the second refracting element 245 can be Si, SiO₂, Ti diffused in LiNbO₃, Ni diffused in LiNbO₃, Ga₍₁₋ₓ₎Al₍ₓ₎As, AlₓGa₍₁₋ₓ₎N, or In₍₁₋ₓ₎Ga₍ₓ₎As_{(1-y)}P_{(y)}.

In one exemplary embodiment, the filter 246 is located between the second refracting element 245 and the light receiver 240. The filter 246 is respectively in direct contact with the second refracting element 245 and the light receiver 240. The filter 246 and the second refracting element 245 have the same cross section. Both the first substrate 223 and the second substrate 243 are sapphire substrate with a refractive index n₃=1.65. Both the first refracting element 225 and the second refracting element 245 are silicon layer with a refractive index n₂=1.40˜1.48. The refractive index of the air is that n₁=1.

According to semiconductor manufacture technology, all the refracting elements could be integrated into a planar waveguide chip including filter and mirrors. As a result, the required mechanism is reduced on size. In the function, the loss of optical transmission is much smaller because of the refractive index of silicon larger than the refractive index of air. Furthermore, it has advantages of less assembly time and cost because all the elements are integrated into a waveguide chip.

It is to be understood that the above-described exemplary embodiments are intended to illustrate rather than limit the disclosure. Any elements described in accordance with any exemplary embodiments is understood that they can be used in addition or substituted in other exemplary embodiments. Exemplary embodiments can also be used together. Variations may be made to the exemplary embodiments without departing from the spirit of the disclosure. The above-described exemplary embodiments illustrate the scope of the disclosure but do not restrict the scope of the disclosure.

Depending on the exemplary embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A light transmitting and receiving device, comprising:
a light transmitting module, wherein the light transmitting module comprises a light transmitter, a first focusing lens, and a first planar waveguide; the first planar waveguide is adjacent to a light exit surface of the light transmitter so that a first laser light, emitted from the light transmitter, enters the first planar waveguide; and the first laser light reaches and passes through the first focusing lens after being refracted by the first planar waveguide; and
a light receiving module, wherein the light receiving module comprises a light receiver, a second focusing lens, and a second planar waveguide; a second laser light enters the second planar waveguide after passing through the second focusing lens; and the second planar waveguide is adjacent to a light incidence surface of the light receiver so that the second laser light enters the light receiver after being refracted by the second planar waveguide.

2. The light transmitting and receiving device of claim 1, wherein the first planar waveguide comprises a first substrate and a first refracting element located on a surface of the first substrate; and the second planar waveguide comprises a second substrate and a second refracting element located on a surface of the second substrate.

3. The light transmitting and receiving device of claim 2, wherein the second planar waveguide further comprises a filter located on the surface of the second substrate.

4. The light transmitting and receiving device of claim 3, wherein the filter is located between the second refracting element and the light receiver.

5. The light transmitting and receiving device of claim 4, wherein the filter directly contacts the second refracting element and the light receiver.

6. The light transmitting and receiving device of claim 2, wherein a material of the first substrate and the second substrate is selected from the group consisting of sapphire, Si₃N₄, SiO₂, GaAs, GaN, LiNbO₃, and LiTaO₃.

7. The light transmitting and receiving device of claim 2, wherein a material of the first refracting element and the second refracting element is selected from the group consisting of Si, SiO₂, Ti diffused in LiNbO₃, Ni diffused in LiNbO₃, Ga₍₁₋ₓ₎Al₍ₓ₎As, AlₓGa₍₁₋ₓ₎N, and In₍₁₋ₓ₎Ga₍ₓ₎As_{(1-y)}P_{(y)}.

8. The light transmitting and receiving device of claim 1, wherein the light receiving module further comprises a filter.

9. A light transmitting and receiving device, comprising:
a light transmitting module, wherein the light transmitting module comprises a light transmitter and a first focusing lens; and
a light receiving module, wherein the light receiving module comprises a light receiver and a second focusing lens;
wherein at least one of the light transmitting module and the light receiving module further comprises a planar waveguide comprising a substrate and a refracting element.

10. The light transmitting and receiving device of claim 9, wherein the planar waveguide further comprises a filter; the filter and the refracting element are located on the same surface of the substrate.

11. A light detection and ranging system comprising: a light transmitting and receiving device, a controlling module, and a processing module; wherein the light transmitting and receiving device comprises:
a light transmitting module, wherein the light transmitting module comprises a light transmitter, a first focusing lens, and a first planar waveguide; the first planar waveguide is adjacent to a light exit surface of the light transmitter so that a first laser light, emitted from the light transmitter, enters the first planar waveguide; and the first laser light reaches and passes through the first focusing lens after being refracted by the first planar waveguide; and
a light receiving module, wherein the light receiving module comprises a light receiver, a second focusing lens, and a second planar waveguide; a second laser light enters the second planar waveguide after passing through the second focusing lens; and the second planar waveguide is adjacent to a light incidence surface of the light receiver so that the second laser light enters the light receiver after being refracted by the second planar waveguide.

12. The light detection and ranging system of claim 11, wherein the first planar waveguide comprises a first substrate and a first refracting element located on a surface of the first substrate; and the second planar waveguide comprises a second substrate and a second refracting element located on a surface of the second substrate.

13. The light detection and ranging system of claim 12, wherein the second planar waveguide further comprises a filter located on the surface of the second substrate.

14. The light detection and ranging system of claim 13, wherein the filter is located between the second refracting element and the light receiver.

15. The light detection and ranging system of claim 14, wherein the filter directly contacts the second refracting element and the light receiver.

16. The light detection and ranging system of claim 12, wherein a material of the first substrate and the second substrate is selected from the group consisting of sapphire, Si₃N₄, SiO₂, GaAs, GaN, LiNbO₃, and LiTaO₃.

17. The light detection and ranging system of claim 12, wherein a material of the first refracting element and the second refracting element is selected from the group consisting of Si, SiO₂, Ti diffused in LiNbO₃, Ni diffused in LiNbO₃, Ga₍₁₋ₓ₎Al₍ₓ₎As, AlₓGa₍₁₋ₓ₎N, and In₍₁₋ₓ₎Ga₍ₓ₎As_{(1-y)}P_{(y)}.

18. The light detection and ranging system of claim 11, wherein the light receiving module further comprises a filter.
